(19) United States
(12) Patent Application Publication
(10) Pub. No.: US 2026/0215991 A1
(43) Pub. Date: Jul. 30, 2026

(54) Swinging Back Rehabilitation and Exercise Device

(71) Applicant: Chirotech Innovation Co., Ltd., New Taipei City (TW)

(72) Inventor: Fu-Mao Kao, New Taipei City (TW)

(21) Appl. No.: 19/386,489

(22) Filed: Nov. 12, 2025

(30) Foreign Application Priority Data
Jan. 24, 2025 (TW) 114103605

(51) Int. Cl. A61H 1/02; A61G 13/00; A61G 13/08; A61G 13/12

(52) U.S. Cl. CPC A61H 1/0222; A61G 13/009; A61G 13/08; A61G 13/121; A61G 13/122; A61G 13/123; A61H 2201/1676

(57) ABSTRACT

A rehabilitation and exercise device comprises: a main base (1), a tail section (2) adapted for supporting a user's buttock, a lower section (3) adapted for supporting the user's thigh, a middle section (4) adapted for supporting the user's abdomen and chest, and a top section (5) adapted for supporting the user's head and a swinging device (6) pivotally mounted on the main base (1) for swinging, tilting, or turning the user for rehabilitation and exercise.

### BACKGROUND OF THE INVENTION:

US 2021/0338513 disclosed a spine regularity rotation motion device for redressing a user's spine to its correct angle or location which includes a T-shaped hanger, a neck traction belt, an n-shaped base, and a horizontal rotary drive platform, wherein the T-shaped hanger is connected to the neck traction belt via a puling belt at one end, and is connected to the n-shaped base through a main elevating post at another end. A user can rest his face on the neck traction belt, which is gently pulled upwards to increase the space between the cervical joints and align the spine to the center. The horizontal rotary drive platform is provided inside the n-shaped base with a correction seat on the top for the user to sit on. The seat allows the hip of the user to move in a regularity rotation manner that is opposite to the directions of the twisted and/or bent lumbar spine or skewed pelvis.

However, such a prior art is just provided for a user who sits on the seat, and can not be used for laying down the user like laying on a bed.

The present inventor has found this drawback and invented the swinging back rehabilitation and exercise device, on which the user can lay down, like on a bed, for comfortable rehabilitation and exercise.

### SUMMARY OF THE INVENTION

The object of the present invention is to provide a rehabilitation and exercise device comprising: a main base, a tail section adapted for supporting a user's buttock, a lower section adapted for supporting the user's thigh, a middle section adapted for supporting the user's abdomen and chest, and a top section adapted for supporting the user's head and a swinging device pivotally mounted on the main base for swinging, tilting, or turning the user in multiple angles for rehabilitation and exercise.

### BRIEF DESCRIPTION OF THE DRAWINGS

FIG. 1 shows a perspective view of the present invention.

FIG. 2 is a side view of FIG. 1.

FIG. 3 is a partial exploded view of the present invention.

FIG. 4 is a side view of the present invention as taken from Line 4-4 of FIG. 3.

FIG. 5 is an exploded view showing the elements of the present invention.

FIG. 6 shows the present invention when tilted leftwardly.

FIG. 7 shows the present invention when tilted rightwardly.

FIG. 8 shows a rightward tilting (or rotation) of the complete device.

FIG. 9 shows a leftward tilting (or rotation) of the device.

FIG. 10 shows the device when reciprocatively operated.

FIG. 11 shows the device when reciprocated in a direction opposite to FIG. 10.

FIG. 12 is a perspective illustration of the present invention as leftwardly swung.

FIG. 13 is a perspective illustration of the present invention as rightwardly swung.

FIG. 14 is an exploded view showing the elements of the present invention when driven by a pinion rotated by a motor.

FIG. 15 shows the leftward swinging of the device as assembled from FIG. 14.

FIG. 16 shows a rightward swinging opposite to FIG. 15.

FIG. 17 is an illustration showing the device being directly driven by a motor mounted on an elevating column.

FIG. 18 is a partial sectional drawing of the device as assembled from FIG. 17.

FIG. 19 shows a leftward tilting of the device of FIG. 18.

FIG. 20 shows a rightward tilting of the device opposite to FIG. 19.

### DETAILED DESCRIPTION:

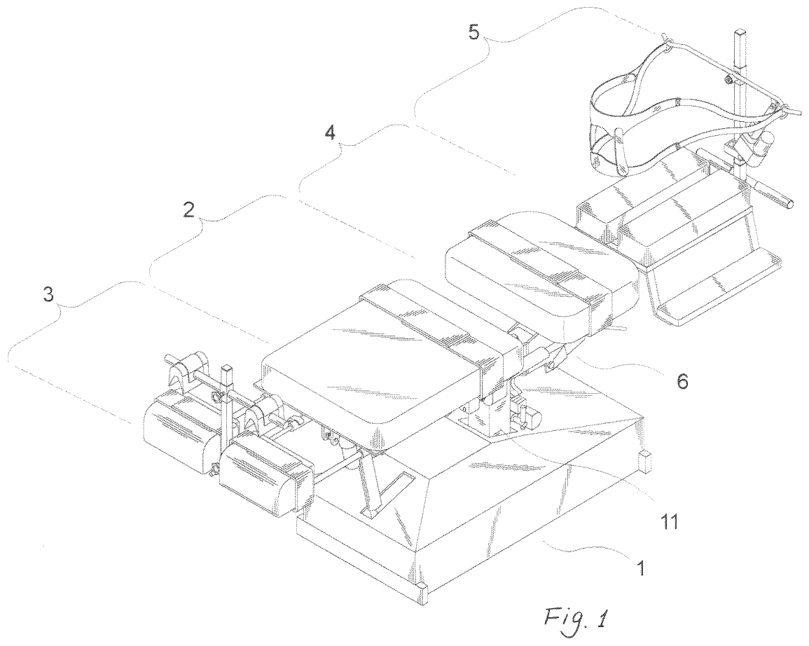

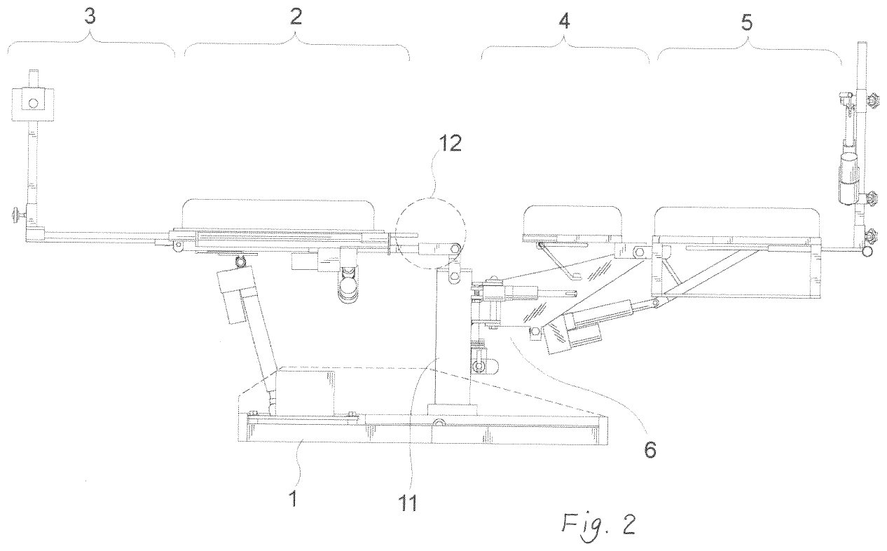

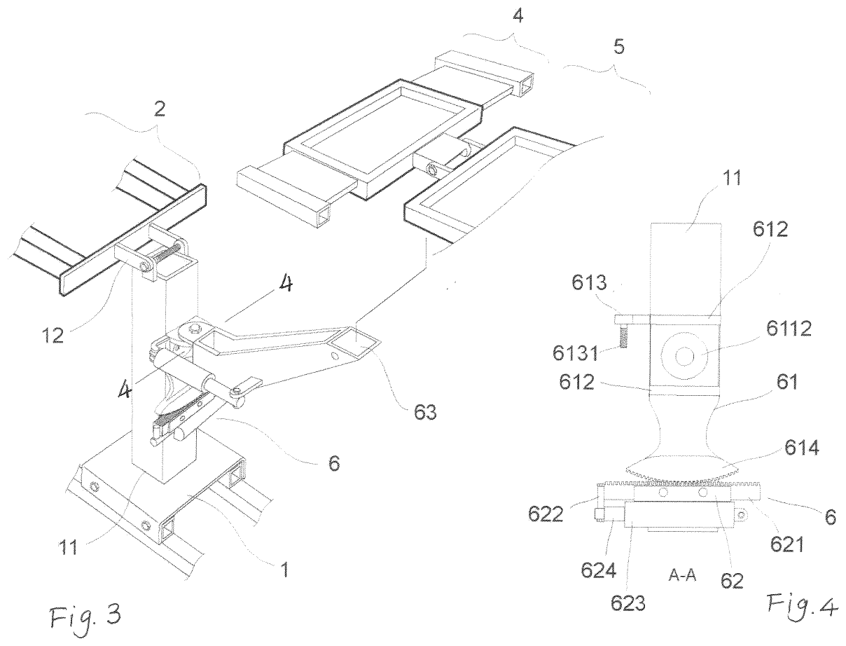

As shown in FIG. 1~5, the present invention comprises: a main base 1, a tail section 2 adapted for supporting a user's buttock, a lower section 3 adapted for supporting the user's thigh, a middle section 4 adapted for supporting the user's abdomen and chest, and a top section 5 adapted for supporting the user's head and a swinging device 6. The tail section 2 is connected with the lower section 3 and is mounted on the main base (1). The middle section 4 is connected with the top section 5.

The main base 1 includes an elevating column 11 formed on the main base 1 and a pivoting joint 12 formed on a top portion of the elevating column 11. The pivoting joint 12 is connected with the tail section 2. A pivoting base 13 is formed on a middle portion of the elevating column 11.

The swinging device 6 comprises: a swinging member 61, a fixing base 62 and a supporting base 63.

The swinging member 61 is formed with a shaft hole 611 therethrough for rotatably engaging the pivoting base 13, having a buffer packing ring 6111 jacketed on the pivoting base 13, within the shaft hole 611. The swinging member 61 includes: a pair of connecting plates 612, 612 symmetrically formed around the shaft hole 611, a side link 613 formed on a side portion of one connecting plate 612, and a sector-gear portion 614 formed on a bottom portion of the swinging member 61. The swinging member 61 is fixed on the elevating column 11 by securing a positioning (or limiting) plate 6112 of the swinging member 61 on the pivoting base 13 of the elevating column 11.

The fixing base 62 is secured to a lower portion of the elevating column 11. The fixing base 62 has a recess formed in the fixing base 62 to be secured with a rack 621 in the recess to be slidably engageable with the sector-gear portion 614 of the swinging member 61. A first reciprocating cylinder 623 is juxtapositionally formed with the fixing base 62 and secured to a bracket 14 formed on the elevating column 11 by bolts 6231. The first reciprocating cylinder 623 includes a telescopic rod 624, which is connected to a transmission portion 622 of the fixing base 62.

The supporting base 63 includes a pair of lugs 632 connected to the pair of connecting plates 612, 612. The supporting base 63 is upwardly connected to the middle section 4 connected with the top section 5. A side link 613 is formed on an upper portion of the supporting base 61. The supporting base 63 includes a side lug 631 formed on a side portion of the supporting base 63 to be coupled to a second reciprocating cylinder 633. The second reciprocating cylinder 633 has another end connected to the side link 613 of the supporting base 61. The connecting plate 612 is pivotally connected with a connecting plate 632 of the supporting base 63 by a bolt 6321. By the way, the supporting base 63 will reciprocatively swing about Y-axis (Y), as actuated by the second reciprocating cylinder 633, with respect to the swinging member 61. The reciprocating cylinder 633 may be operated electrically, hydraulically or pneumatically.

The first reciprocating cylinder 623 is operated to telescopically reciprocate the telescopic rod 624 to drive the rack 621 in the fixing base 62 reciprocatively. The sector-gear portion 614, as engageable with the rack 621, will then be swung or turned as driven by the rack 621 about the pivoting base 13, either rightwardly or leftwardly. Accordingly, the top section 5 and the middle section 4, as linked to the swinging member 61, will then be swung, tilted or turned rightwardly or leftwardly in variable angles about X-axis (X).

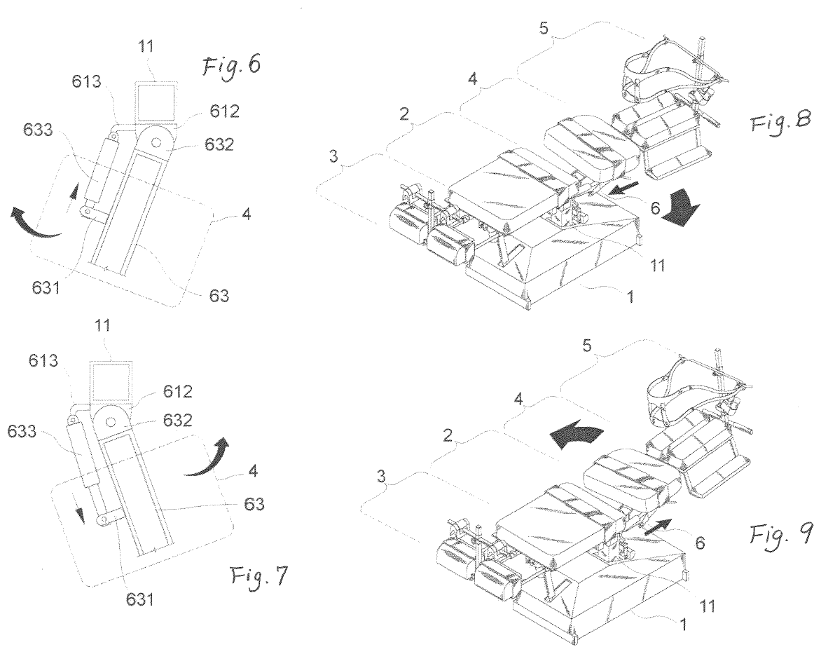

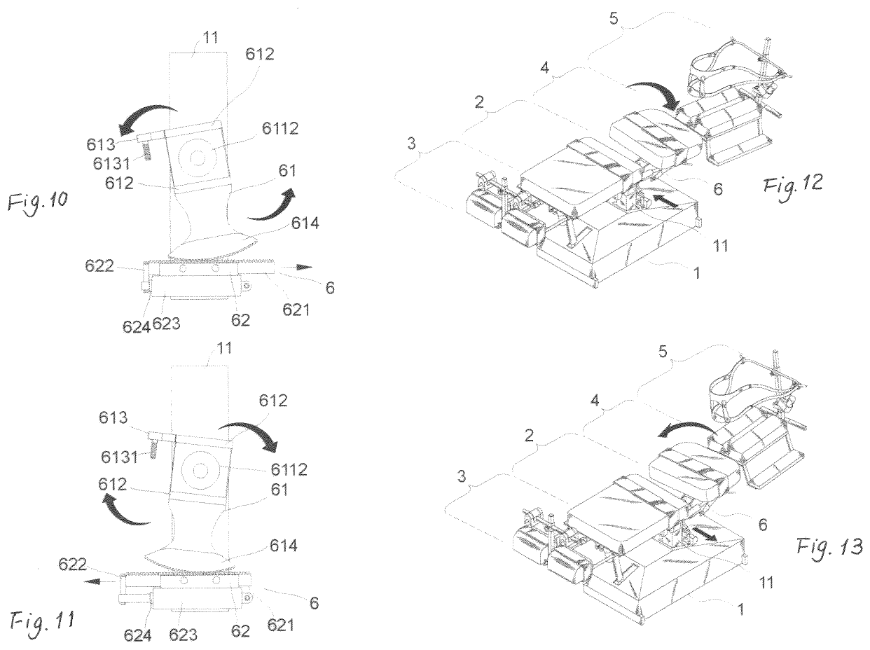

As shown in FIG. 6~13, when the first reciprocating cylinder 623 is operated, the telescopic rod 624 will be reciprocatively driven to reciprocatively drive the rack 621 along the recess in the fixing base 62 since the sector-gear portion 614 is engaged with the rack 621 of the fixing base 62. The swinging member 61 is pivotally coupled to the pivoting base 13. The sector-gear portion 614 is formed on the bottom of the swinging member 61 and engaged with the rack 621 of the fixing base 62. Therefore, the swinging member 61 will rotatably or pivotally swing about the pivoting base 13.

The connecting plate 612 of the swinging member 61 is pivotally connected to the connecting 632 of the supporting base 63, whereby when the connecting plate 612 of the swinging member 61 is pivotally swung in the shaft hole 611 formed in the connecting plate 612, the swinging member 61 will tilt the supporting base 63 either rightwarding or leftwardly. The supporting base 63 is upwardly connected to the top section 5 and middle section 4 so as to reciprocatively tilt the middle section 4 and top portion 5 either rightwardly or leftwardly for helping rehabilitation of the user's spine, or for exercising the user's head, chest and abdomen either rightwardly or leftwardly.

As shown in FIG. 7~13, the swinging member 61 may be swung rightwardly or leftwardly about a X-axis (X) axially formed in the pivoting base 13, and the supporting base 63 may be swung rightwardly or leftwardly about a Y-axis (Y) defined in a center line of a pair of bolt holes formed in the pair of connecting plates 612 because the supporting base 63 has its side lug 631 pivotally connected to a first end of the second reciprocating cylinder 633, while the swinging member 61 has its side link 613 pivotally connected to a second end of the second reciprocating cylinder 633. By the way, the rightwardly or leftwardly swinging supporting base 63 will drive the middle section 4 and top section 5 connected to the middle section 4 so as to move the user's spine rightwardly or leftwardly for rehabilitation or exercise.

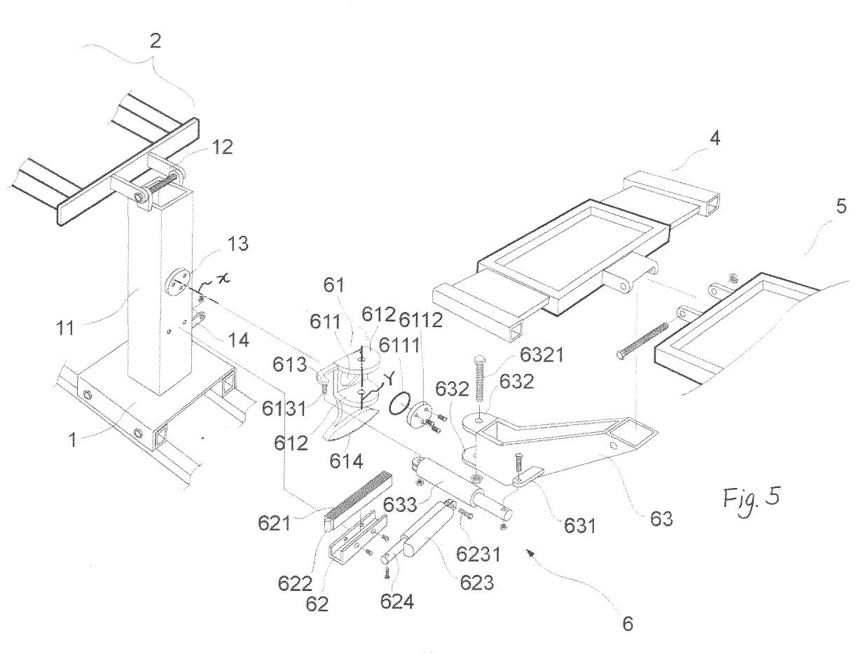

As shown in FIG. 5, the buffer packing ring 6111 is circumferentially disposed in the shaft hole 611 of swinging member 61 and snugly engaged in between the pivoting base 13 and positioning plate 6112 for pivoting the connecting plates 612 around the pivoting base 13 for obtaining the following advantages or functions:
1. Providing shock absorbing: During the swinging motion of the swinging member 61 pivotally rotated about the pivoting base 13, the buffer packing ring 6111 may absorb the shock or vibration energy for reducing the vibration during rehabilitation or exercise.
2. Enhancing stability: The buffer packing ring 6111 provides a soft buffer to prevent rigid friction among the related pivoting parts, thereby enhancing the stability of the swinging device 6.
3. Protecting operation elements: The packing ring 6111 will buffer or dampen the stress or torque of the related elements of the swinging device 6, thereby prolonging their service life.
4. Improving exercise precision: As effected by ring 6111, the vibration or shock impacting is appreciably reduced, thereby improving the rehabilitation or exercise precision of the angular swinging of the user's head, chest and abdomen.

Accordingly, a swinging motion of the user may be promoted by the function of the buffer packing ring 6111, such as: vibration reduction, motion stability, safe protection, rehabilitation or exercise precision, structural durability and reliable performance. The user may lay down on the device, like on a bed, for comfortable use.

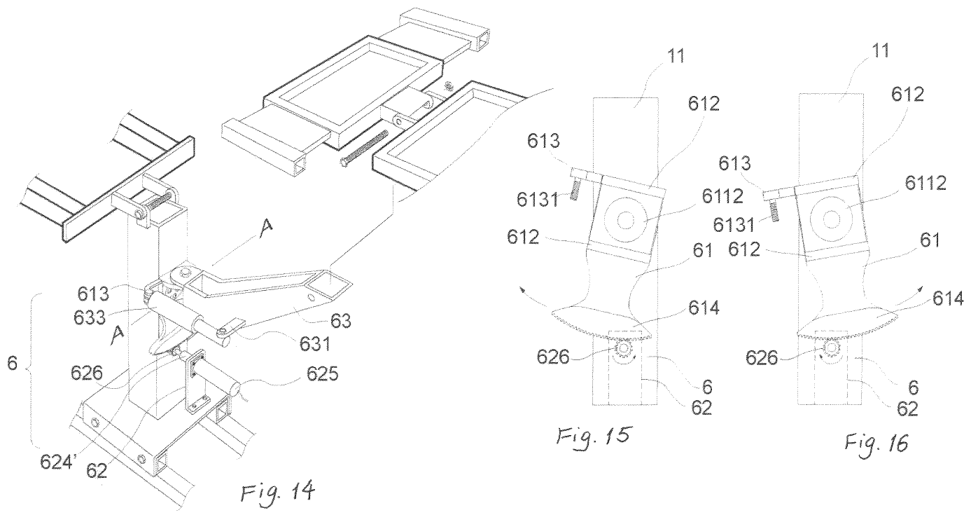

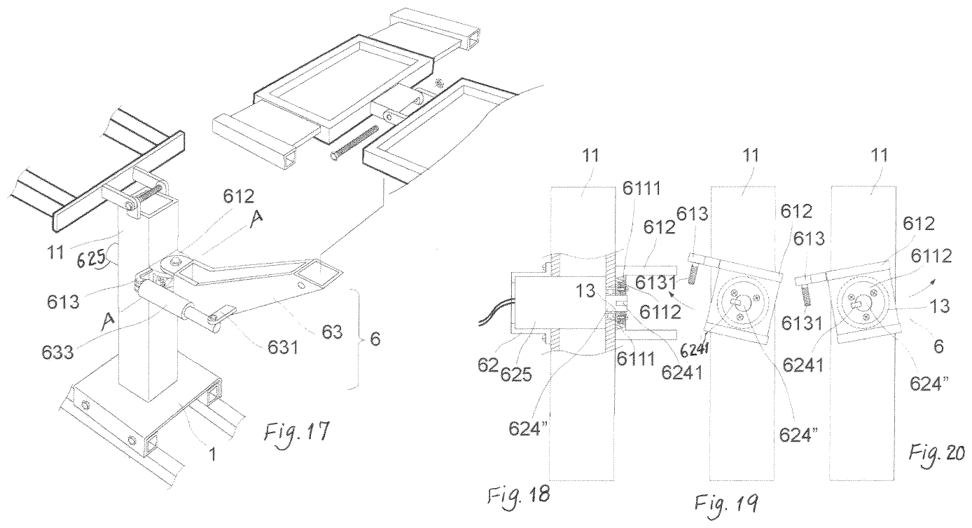

As shown in FIG. 14~16, a motor 625 is mounted on a top portion of the fixing base 62 juxtaposed to the elevating column 11 on the main base 1. A motor shaft 624′ of the motor 625 has a pinion 626 axially connected to the motor shaft 624′. The pinion 626 is engaged with the sector-gear portion 614 of the swinging member 61 for angularly driving the swinging member 61. The motor 625 will drive the swinging member 61 directly for stably, precisely, smoothly swinging the user's body including spine.

As shown in FIG. 17~20, a motor 625 is secured on a fixing base 62 mounted on an upper portion of the elevating column 11, having a motor shaft 624″ protruding through the elevating column 11 to be connected to a connecting plate 612 and is rotated in the pivoting base 13 as packed by the buffer packing ring 6111 between the pivoting base 13 and the connecting plate 612. A locking pin 6241 is provided for coupling the positioning plate 6112 and the motor shaft 624″. The connecting plate 612 is connected to the supporting base 63. So, when the motor 625 is rotated clockwise or counter clockwise to drive the connecting plate 612 and the supporting base 63 rightwardly or leftwardly about the pivoting base 13, the user's chest and abdomen and head will be tilted or swung either rightwardly or leftwardly in multiple angles.

The present invention may be further modified without departing from the spirit and scope of the present invention.

I claim:

1. A rehabilitation and exercise device comprising:
a main base (1), a tail section (2) formed on said main base (1) adapted for supporting a user's buttock, a lower section (3) connected to said tail section (2) adapted for supporting a user's thigh, a middle section (4) connected to said lower section (3) adapted for supporting a user's abdomen and chest, and a top section (5) connected to said middle section (4) adapted for supporting a user's head, and a swinging device (6) pivotally mounted on said main base (1);
said main base (1) including an elevating column (11) formed on the main base (1) and a pivoting joint (12) formed on a top portion of the elevating column (11), said pivoting joint (12) connected with the tail section (2), a pivoting base (13) formed on a middle portion of the elevating column (11);
said swinging device (6) comprising: a swinging member (61), a fixing base (62) and a supporting base (63);
said swinging member (61) formed with a shaft hole (611) therethrough for rotatably engaging the pivoting base (13), having a buffer packing ring (6111) jacketed on the pivoting base (13) within the shaft hole (611), said swinging member (61) including: a pair of connecting plates (612, 612) symmetrically formed around the shaft hole (611), a side link (613) formed on a side portion of one said connecting plate (612), and a sector-gear portion (614) formed on a bottom portion of the swinging member (61), said swinging member (61) fixed on the elevating column (11) by securing a positioning plate (6112) of the swinging member (61) on the pivoting base (13) of the elevating column (11);
said fixing base (62) secured to a lower portion of the elevating column (11), said fixing base (62) having a recess formed in the fixing base (62) to be secured with a rack (621) in the recess to be slidably engageable with the sector-gear portion (614) of the swinging member (61), a first reciprocating cylinder (623) juxtapositionally formed with the fixing base (62) and secured to a bracket (14) formed on the elevating column (11) by bolts (6231), said first reciprocating cylinder (623) including a telescopic rod (624), which is connected to a transmission portion (622) of the fixing base (62);
said supporting base (63) including a pair of lugs (632) connected to the pair of connecting plates (612, 612), said supporting base (63) upwardly connected to the middle section

(4) connected with the top section (5), a side link (613) formed on an upper portion of the supporting base (61), said supporting base (63) including a side lug (631) formed on a side portion of the supporting base (63) to be coupled to a second reciprocating cylinder (633), said second reciprocating cylinder (633) having another end connected to the side link (613) of the supporting base (61), said connecting plate (612) pivotally connected with a connecting plate (632) of the supporting base (63) by a bolt (6321);
whereby the supporting base (63) is reciprocatively swung about a Y-axis (Y) defined in a center line of a pair of bolt holes formed in a pair of said connecting plates (612), as actuated by the second reciprocating cylinder (633), with respect to the swinging member (61), to swing the top section (5) and middle section (4) rightwardly or leftwardly;
and whereby said first reciprocating cylinder (623) is operated to telescopically reciprocate the telescopic rod (624) to drive the rack (621) in the fixing base (62) reciprocatively, said sector-gear portion (614), as engageable with the rack (621), will then be swung or turned as driven by the rack (621) about the pivoting base (13), either rightwardly or leftwardly, so that the top section (5) and the middle section (4), as linked to the swinging member (61), will then be tilted or turned rightwardly or leftwardly in variable angles about X-axis (X) axially defined in a center of said pivoting base (13).

2. A device of claim 1, wherein said swinging member (61) is formed with a shaft hole (611) having a buffer packing ring (6111) circumferentially disposed in said shaft hole (611).

3. A device of claim 1, wherein said swinging member (61) is pivotally engaged on the pivoting base (13) and is limited by a positioning plate (6112) secured to said pivoting base (13).

4. A device of claim 1, wherein said rack (621) includes a transmission portion (622) connected to said telescopic rod (624) of said first reciprocating cylinder (623).

5. A device of claim 4, wherein said first reciprocating cylinder (623) is operated electrically, hydraulically or pneumatically.

6. A device of claim 1, wherein said swinging member (61) includes a side link (613) pivotally connected with said second reciprocating cylinder (633) having a side lug (631) pivotally connected to said supporting base (63) for swinging said supporting base (63) rightwardly or leftwardly.

7. A device of claim 6, wherein said second reciprocating cylinder (633) is operated electrically, pneumatically or hydraulically.

8. A device of claim 1, wherein a fixing base (62) is mounted on said main base (1) juxtaposed to said elevating column (11), having a motor (625) formed on said fixing base (62), and a motor shaft (624) of said motor (625) secured with a pinion (626) on said motor shaft (624) to be engaged with said rack (614).

9. A device of claim 1, wherein said fixing base (62) has a motor (625) secured on said fixing base (62) mounted on an upper portion of the elevating column (11), having a motor shaft (624) protruding through the elevating column (11) to be connected to a connecting plate (612) and is rotated in the pivoting base (13) as packed by the buffer packing ring (6111) between the pivoting base (13) and the connecting plate (612); and
a locking pin (6241) coupling the positioning plate (6112) and the motor shaft (624).

10. A device of claim 9, wherein said connecting plate (612) is further connected to a supporting base (63) for supporting a middle section (4) and a top section (5) of the device.
